(19) United States
(12) Patent Application Publication
(10) Pub. No.: US 2022/0351692 A1
(43) Pub. Date: Nov. 3, 2022

(54) METHOD FOR DIMMING AND DISPLAY DEVICE

(71) Applicant: AU Optronics Corporation, Hsin-Chu (TW)

(72) Inventors: Shao-Ting CHEN, HSIN-CHU (TW); Yi-Fan LIN, HSIN-CHU (TW); Chi-Lung YEH, HSIN-CHU (TW); Kai-Yuan SIAO, HSIN-CHU (TW)

(21) Appl. No.: 17/510,419

(22) Filed: Oct. 26, 2021

(30) Foreign Application Priority Data
Apr. 29, 2021 (TW) 110115617

(51) Int. Cl. G09G 3/34; G09G 3/36

(52) U.S. Cl. CPC G09G 3/3406; G09G 3/3611; G09G 2320/0233; G09G 2330/021

(57) ABSTRACT

A method for dimming is adapted for a display device. The method for dimming includes the steps of: obtaining a plurality of first area peak luminance of a plurality of areas of a panel and a backlight plate of the display device; averaging the plurality of first area peak luminance to obtain an overall peak luminance value; looking the overall peak luminance value up in a lookup table to obtain a luminance adjustment value; and adjusting the plurality of first area peak luminance of the plurality of areas into a plurality of second area peak luminance. The plurality of first area peak luminance are a same with or are different from the plurality of second area peak luminance.

### CROSS-REFERENCE TO RELATED APPLICATION

This application claims priority to Taiwan Application Serial Number 110115617, filed on Apr. 29, 2021, which is herein incorporated by reference in its entirety.

### BACKGROUND

### Field of Invention

The present disclosure relates to a display technology field. More particularly, the present disclosure relates to a method for dimming and a display device.

### Description of Related Art

A design of a mini light emitting diode of a display device tends to improve a quality of a display picture. When a display device is in a standard Dynamic Range (SDR) mode, a display picture of a display device has areas of high gray scales and areas of low gray scales. Light emitting diodes of areas of high gray scales are configured to provide a higher luminance. Light emitting diodes of areas of low gray scales are configured to provide a lower luminance. Therefore, a display device can provide a high luminance and a high contrast effect. When a color of a display picture approaches white, a high luminance provided by light emitting diodes will cause discomfort to user's eyes. In addition, a display device will increase power consumption to maintain light emitting diodes at a high luminance.

For the foregoing reason, there is a need to provide other suitable method for dimming to solve the problems of the prior art.

### SUMMARY

One aspect of the present disclosure provides a method for dimming. The method for dimming is adapted for a display device. The method for dimming includes the following steps of: obtaining a plurality of first area peak luminance of a plurality of areas of a panel and a backlight plate of the display device; averaging the plurality of first area peak luminance to obtain an overall peak luminance value; looking the overall peak luminance value up in a lookup table to obtain a luminance adjustment value; and adjusting the plurality of first area peak luminance of the plurality of areas into a plurality of second area peak luminance. The plurality of first area peak luminance are the same with or are different from the plurality of second area peak luminance.

Another aspect of the present disclosure provides a display device. The display device includes a panel, a memory, a timing control and calculator, and a backlight plate area light adjuster. The memory is configured to store a lookup table. The timing control and calculator is coupled to the panel, a backlight plate, and the memory. The timing control and calculator is configured to obtain a plurality of first area peak luminance of a plurality of areas of a panel and a backlight plate of the display device to average the plurality of first area peak luminance so as to obtain an overall peak luminance value. The timing control and calculator is configured to look the overall peak luminance value up in a lookup table to obtain a luminance adjustment value. The backlight plate area light adjuster is coupled to the panel, the backlight plate, the memory, and timing control and calculator. The backlight plate area light adjuster is configured to adjust the plurality of first area peak luminance of the plurality of areas into a plurality of second area peak luminance according to the luminance adjustment value. The plurality of first area peak luminance are a same as or are different from the plurality of second area peak luminance.

### BRIEF DESCRIPTION OF THE DRAWINGS

The present disclosure can be more fully understood by reading the following detailed description of the embodiment, with reference made to the accompanying drawings as follows:

FIG. 1 depicts a schematic diagram of a display device according to one embodiment of the present disclosure;

FIG. 2 depicts a flow chart of a method for dimming according to one embodiment of the present disclosure;

FIG. 3 depicts a schematic diagram of an original state of a plurality of peak luminance of areas of a panel of a display device according to one embodiment of the present disclosure; and

FIG. 4 depicts a schematic diagram of a state after dimming of a plurality of peak luminance of areas of a panel of a display device according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise.

Furthermore, it should be understood that the terms, “comprising”, “including”, “having”, “containing”, “involving” and the like, used herein are open-ended, that is, including but not limited to.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

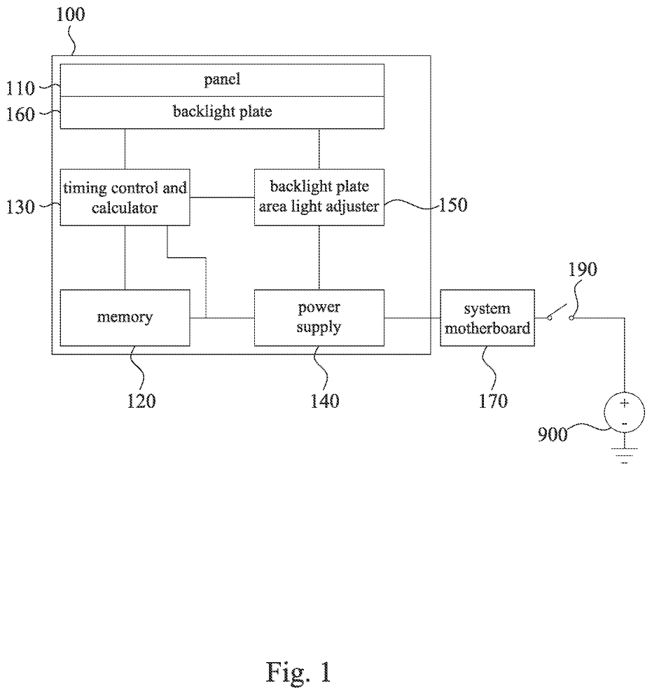

FIG. 1 depicts a schematic diagram of a display device 100 according to one embodiment of the present disclosure. In some embodiments, please refer to FIG. 1, the display device 100 includes a panel 110, a memory 120, a timing control and calculator 130, a power supply 140, a backlight plate area light adjuster 150, and a backlight plate 160. In some embodiments, the display device 100 includes one of a mobile device, a computer, and a laptop.

In some embodiments, the panel 110 includes one of an In-Plane-Switching (IPS) liquid crystal panel, a vertical alignment liquid crystal (VA) liquid crystal panel, and a twisted nematic liquid crystal (TN) panel. In some embodiments, the panel 110 includes the backlight plate 160.

In some embodiments, the memory 120 includes flash memories, hard disk drivers (HDD), solid state drives (SSD), dynamic random access memories (DRAM), or static random access memories (SRAM).

In some embodiments, the timing control and calculator 130 includes but not limited to a single processor and the integration of many micro-processors, for example, timing controller integrated circuits or application specific integrated circuits, (ASIC). In some embodiments, the timing control and calculator 130 is coupled to the panel 110, the memory 120, the power supply 140, the backlight plate area light adjuster 150, and the backlight plate 160.

In some embodiments, the timing control and calculator 130 is configured to detect all the light of a display picture emitted by the display device 100. In some embodiments, the timing control and calculator 130 is configured to detect all the light emitted by a plurality of pixels of the display device 100 and the backlight plate 160 in the panel 110. In some embodiments, the timing control and calculator 130 is configured to calculate an internal voltage, a current, or a duty cycle of the display device 100 so as to obtain a luminance of all the light of a display picture emitted by the display device 100.

In some embodiments, the power supply 140 is coupled to the memory 120, the timing control and calculator 130, the backlight plate area light adjuster 150, and a system motherboard 170. The system motherboard 170 is coupled to a power source 900 via a switch 190 to charge the system motherboard 170 and the display device 100. It should be noted that the switch 190 is only used to express a turned-on state or a turned-off state so as to indicate whether the display device 100 and the system motherboard 170 are coupled to the power source 900 for charging. The timing control and calculator 130 is configured to determine the display device 100 in a performance mode or an energy-saving mode according to a state of whether the system motherboard is coupled to the power source or not.

In some embodiments, the backlight plate area light adjuster 150 is coupled to the panel 110, the timing control and calculator 130, the power supply 140, and the backlight plate 160. The backlight plate area light adjuster 150 is configured to adjust all the light of a display picture emitted by the display device 100. In some embodiments, the backlight plate area light adjuster 150 is configured to adjust all the light emitted by the plurality of pixels of the display device 100 and the backlight plate 160 in the panel 110.

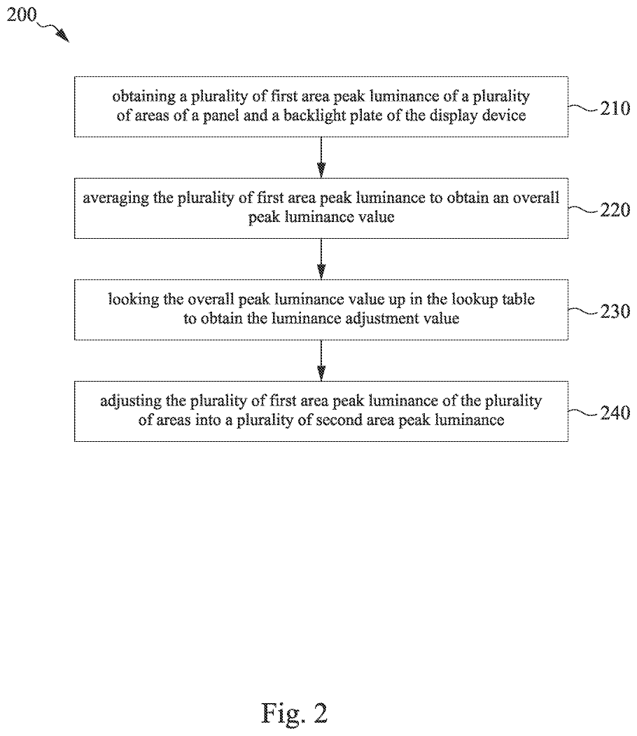

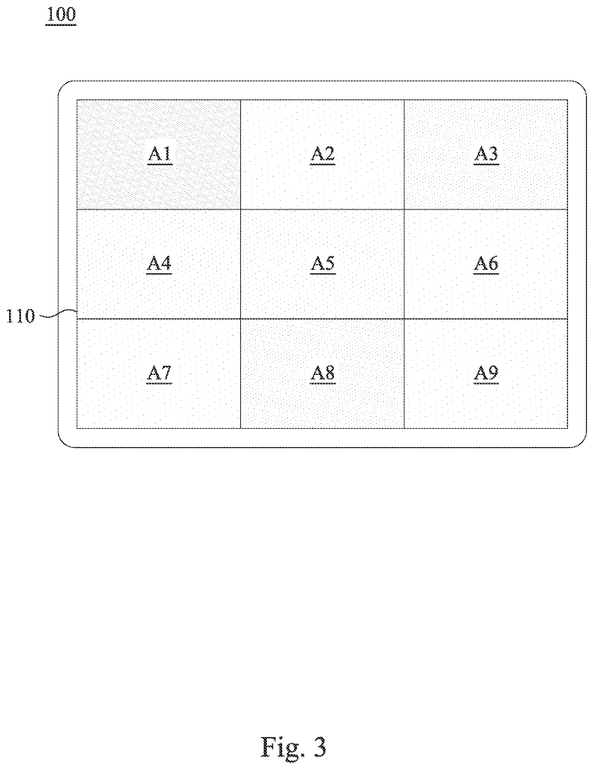

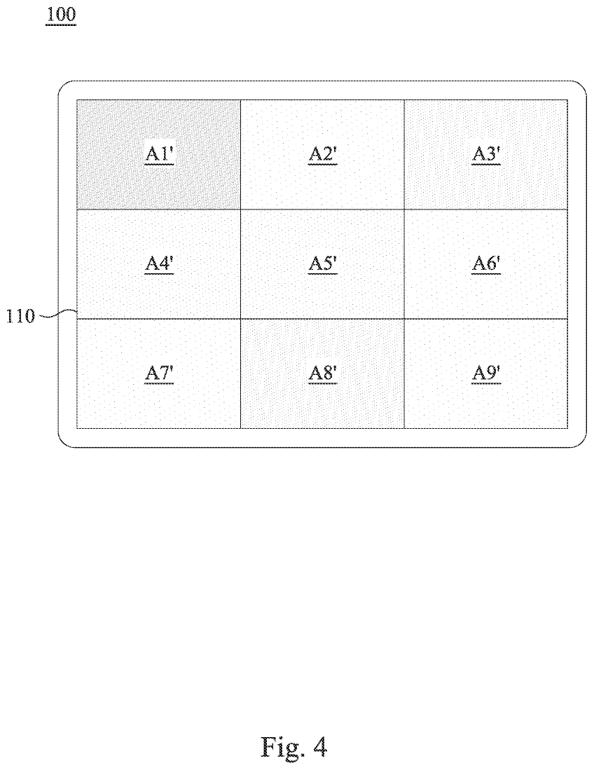

In some embodiments, in order to facilitate the understanding of an operation of the display device 100, please refer to FIG. 1 to FIG. 4 together. FIG. 2 depicts a flow chart of a method 200 for dimming according to one embodiment of the present disclosure. FIG. 3 depicts a schematic diagram of an original state of a plurality of peak luminance of areas of a panel 110 of a display device 100 according to one embodiment of the present disclosure. FIG. 4 depicts a schematic diagram of a state after dimming of a plurality of peak luminance of areas of a panel 110 of a display device 100 according to one embodiment of the present disclosure. The display device 100 shown in FIG. 3 and FIG. 4 are both corresponding to the display device 100 shown in FIG. 1. In some embodiments, the method 200 for dimming is executed by the display device 100 shown in FIG. 1. The method 200 for dimming of the present disclosure includes the following steps of:

In step 210, obtaining a plurality of first area peak luminance of a plurality of areas of a panel and a backlight plate of the display device.

In some embodiments, please refer to FIG. 1 to FIG. 3, at first, a display picture of the panel 110 of the display device 100 is divided into a plurality of areas as shown in FIG. 3. Then, the timing control and calculator 130 of the display device 100 in FIG. 1 is configured to obtain the plurality of first area peak luminance of the plurality of areas (e.g. area A1 to area A9) of the panel 110 shown in FIG. 3 and the backlight plate 160 shown in FIG. 1. In some embodiments, the timing control and calculator 130 of the display device 100 in FIG. 1 is configured to detect all the light of the plurality of areas of the display picture emitted by the display device 100 so as to calculate the plurality of first area peak luminance. In some embodiments, the plurality of first area peak luminance include average values or average ratio values.

In practice, the plurality of areas of the display device 100 shown in FIG. 3 can be divided into 512 or more areas. It should be noted that a number and a size of the plurality of areas of the display device 100 are not limited to the embodiments shown in FIG. 3.

In step 220, averaging the plurality of first area peak luminance to obtain an overall peak luminance value.

In some embodiments, please refer to FIG. 1 to FIG. 3, the timing control and calculator 130 of the display device 100 shown in FIG. 1 is configured to average the plurality of first area peak luminance of the plurality of areas of the panel 110 shown in FIG. 3 and the backlight plate 160 shown in FIG. 1 so as to obtain an overall peak luminance value. In some embodiments, the overall peak luminance value includes an average value or an average ratio value. For example, the timing control and calculator 130 is configured to obtain the plurality of first area peak luminance from a first area A1 to a ninth area A9 of the panel 110 and the backlight plate 160. The plurality of first area peak luminance from the first area A1 to the ninth area A9 are 10%, 70%, 30%, 50%, 50%, 70%, 70%, 30%, and 70% respectively. The timing control and calculator 130 is configured to add the aforementioned plurality of first area peak luminance to average so as to obtain an overall peak luminance value of 50%.

In step 230, looking the overall peak luminance value up in a lookup table to obtain a luminance adjustment value.

In some embodiments, please refer to FIG. 1 and FIG. 2, the memory 120 of the display device 100 is configured to store a look table about the plurality of first area peak luminance. The timing control and calculator 130 is configured to look the overall peak luminance value up in a lookup table to obtain a luminance adjustment value. The look table about the plurality of first area peak luminance is listed as below:

TABLE 1

| overall peak | luminance |
|---|---|
| luminance value (OPR) | adjustment value |
| 10% | 100% |
| 30% | 85% |
| 50% | 75% |
| 70% | 60% |
| 100% | 50% |

In practice, values in Table 1 can be customized, and be not limited to the embodiments shown in Table 1. In addition, when a luminance adjustment value is 100%, the luminance of panel 110 before adjustment is the same as the luminance of panel 110 after adjustment. The luminance of the backlight plate 160 before adjustment is also the same as the luminance of the backlight plate 160 after adjustment.

Following the example listed in step 220, the timing control and calculator 130 is configured to obtain the overall peak luminance value of 50%. Then, the timing control and calculator 130 is configured to look the overall peak luminance value of 50% up in the Table 1 in the memory 120. After looking up to the overall peak luminance value up of 50% in Table 1, the timing control and calculator 130 is configured to obtain a luminance adjustment value of 75%, and is configured to transmit the luminance adjustment value to the backlight plate area light adjuster 150.

In step 240, adjusting the plurality of first area peak luminance of the plurality of areas into a plurality of second area peak luminance.

In some embodiments, please refer to FIG. 1 to FIG. 4, the backlight plate area light adjuster 150 of the display device 100 is configured to adjust the plurality of first area peak luminance of the plurality of areas of the panel 110 and the backlight plate 160 into a plurality of second area peak luminance according to the luminance adjustment value. The plurality of first area peak luminance are the luminance before adjustment. The plurality of second area peak luminance are the luminance after adjustment. In some embodiments, the plurality of first area peak luminance are the same as or are different from the plurality of second area peak luminance. In some embodiments, a method for dimming according to the luminance adjustment value includes one of an addition, a subtraction, a multiplication, a division, and a combination of the foregoing calculation methods.

Following the example listed in step 230, the backlight plate area light adjuster 150 is configured to adjust the plurality of first area peak luminance from the first area A1 to the ninth area A9 of the display device 100 shown in FIG. 3 according to the luminance adjustment value of 75% respectively. The plurality of first area peak luminance are adjusted into the plurality of second area peak luminance from a first area A1 ′to a ninth area A9′of the display device 100 shown in FIG. 4. The plurality of first area peak luminance are the same as or are different from the plurality of second area peak luminance. The plurality of first area peak luminance are not limited to the embodiments shown in the figures. In detail, the plurality of first area peak luminance from the first area A1 to the ninth area A9 shown in FIG. 3 is 10%, 70%, 30%, 50%, 50%, 70%, 70%, 30%, and 70% respectively. Each of the plurality of first area peak luminance is multiplied by the luminance adjustment value of 75%. Then, adjusted values of the plurality of second area peak luminance from the first area A1 ′to the ninth area A9 shown in FIG. 4 are 7.5%, 52.5%, 22.5%, 37.5%, 37.5%, 52.5%, 52.5%, 22.5%, and 52.5% respectively.

In some embodiments, please refer to FIG. 1 and FIG. 2, in step 230 of the method 200 for dimming of the present disclosure, if the timing control and calculator 130 is configured to look the overall peak luminance value up in a lookup table to obtain a luminance adjustment value, and the luminance adjustment value is not obtained by looking the overall peak luminance value up in the lookup table, the timing control and calculator 130 is configured to calculate a luminance adjustment value. Then, the timing control and calculator 130 is configured to calculate the luminance adjustment value according to the overall peak luminance value and the lookup table.

In some embodiments, the timing control and calculator 130 is configured to calculate the luminance adjustment value according to overall peak luminance value and the lookup table including at least one of an interpolation and an extrapolation. For example, the timing control and calculator 130 of the display device 100 obtains an overall peak luminance value of 54%. The timing control and calculator 130 is configured to look the overall peak luminance value of 54% up in the Table 1 in the memory 120. When the timing control and calculator 130 has not obtained a luminance adjustment value corresponding to the overall peak luminance value of 54%, the timing control and calculator 130 is configured to calculate a luminance adjustment value by an interpolation. The timing control and calculator 130 is configured to interpolate to obtain a luminance adjustment value of 72% according to the overall peak luminance value of 54% and the lookup table shown in Table 1.

In some embodiments, the memory 120 of the display device 100 is configured to store lookup tables about the plurality of first area peak luminance. The lookup tables about the plurality of first area peak luminance include a first lookup table shown in Table 1 and a second lookup table. The second lookup table about the plurality of first area peak luminance is listed as below:

TABLE 2

| overall peak | luminance |
|---|---|
| luminance value (OPR) | adjustment value |
| 10% | 100% |
| 30% | 91% |
| 50% | 85% |
| 70% | 76% |
| 100% | 70% |

As shown in Table 2, the first lookup table shown in Table 1 is different from the second lookup table lookup table shown in Table 2. Each of first adjustment values of the luminance in the first lookup table is the same as or is different from each of second luminance adjustment value in the second lookup table.

In some embodiments, please refer to FIG. 1, FIG. 2, Table 1, and Table 2, in step 230 of the method 200 for dimming of the present disclosure, the timing control and calculator 130 of the display device 100 is configured to selecting one of the first lookup table and the second lookup table so as to obtain a first luminance adjustment value corresponding to the first lookup table or obtain a second luminance adjustment value corresponding to the second lookup table according to the overall peak luminance value. For example, the timing control and calculator 130 obtains an overall peak luminance value of 70%. The timing control and calculator 130 is configured to selecting one of the first lookup table shown in Table 1 and the second lookup table shown in Table 2 so as to obtain a first luminance adjustment value of 60% corresponding to the first lookup table or obtain a second luminance adjustment value of 76% corresponding to the second lookup table according to the overall peak luminance value 70%. It should be noted that the timing control and calculator 130 is configured to select one of the first lookup table and the second lookup table according to ambient light or an instruction from a user.

In some embodiments, please refer to FIG. 1, the timing control and calculator 130 of the display device 100 is configured to detect a luminance of the panel in a first dynamic range mode. The timing control and calculator 130 is configured to detect a luminance of the panel in a second dynamic range mode. The luminance of the panel in the first dynamic range mode is different from the luminance of the panel in the second dynamic range mode. It should be noted that a dynamic range (DR) is defined as a ratio of a brightest luminance and a darkest luminance in a scene or a display picture. A difference between the brightest and the darkest luminance is greater, the dynamic range is higher. For example, the first dynamic range mode is high dynamic range (HDR) 1000. The second dynamic range mode is HDR 600. It should be noted that the definitions of HDR 1000 and HDR 600 have different unit ranges of light intensity (candles/nits) according to a display central area, an entire display area, and a display time of the display device 100. Different lookup tables can be selected for different dynamic range modes.

In some embodiments, please refer to FIG. 1, the timing control and calculator 130 is configured to determine whether the display device 100 is in the performance mode or the energy-saving mode according to the switch 190. The timing control and calculator 130 is configured to determine the panel 110 in one of the first dynamic range mode and the second dynamic range mode according to an instruction. In some embodiments, the display device 100 can be in four different luminance modes. In other words, the display device 100 is configured to display a plurality of luminance according to an actual need and an environment.

Based on the above embodiments, the method 200 for dimming of the present disclosure is mainly used when a luminance of a display picture of display device is too strong, the method 200 for dimming can be used to maintain light of the display picture emitted by the display device 100 at a proper luminance so as to save power consumption of the display device 100 and protect eyes of a user. The method 200 for dimming can also maintain a high contrast when the display picture emitted by the display device 100 is relatively dark.

Based on the above embodiments, the present disclosure provides a method and a display device so as to adjust a display picture of a display device in a proper luminance and save a power consumption of a display device.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

1. A method for dimming, adapted for a display device, wherein the method for dimming comprises:
obtaining a plurality of first area peak luminance, one for each of a plurality of areas of a panel and a backlight plate of the display device, wherein each of the plurality of areas comprises a plurality of pixels;
averaging the plurality of first area peak luminance to obtain an overall peak luminance value for the panel;
looking the overall peak luminance value up in a lookup table to obtain a luminance adjustment value; and
adjusting the plurality of first area peak luminance of the plurality of areas into a plurality of second area peak luminance according to the luminance adjustment value, wherein when the luminance adjustment value is fractional, the plurality of first area peak luminance are different from the plurality of second area peak luminance.

2. The method for dimming of claim 1, wherein looking the overall peak luminance value up in the lookup table to obtain the luminance adjustment value comprises:
calculating the luminance adjustment value if the luminance adjustment value is not obtained by looking the overall peak luminance value up in the lookup table; and
calculating the luminance adjustment value according to the overall peak luminance value and the lookup table.

3. The method for dimming of claim 2, wherein calculating the luminance adjustment value according to the overall peak luminance value and the lookup table comprises at least one of an interpolation and an extrapolation.

4. The method for dimming of claim 1, wherein the lookup table comprises a first lookup table and a second lookup table, and the first lookup table is different from the second lookup table, wherein looking the overall peak luminance value up in the lookup table to obtain the luminance adjustment value comprises:
selecting one of the first lookup table and the second lookup table so as to obtain a first luminance adjustment value corresponding to the first lookup table or obtain a second luminance adjustment value corresponding to the second lookup table according to the overall peak luminance value.

5. The method for dimming of claim 4, wherein the first luminance adjustment value is a same as or is different from the second luminance adjustment value.

6. A display device, comprising:
a panel;
a memory, configured to store a lookup table;
a timing control and calculator, coupled to the panel, a backlight plate, and the memory, and configured to obtain a plurality of first area peak luminance, one for each of a plurality of areas of a panel and a backlight plate of a display device to average the plurality of first area peak luminance so as to obtain an overall peak luminance value for the panel, wherein each of the plurality of areas comprises a plurality of pixels, wherein the timing control and calculator is configured to look the overall peak luminance value up in a lookup table to obtain a luminance adjustment value; and
a backlight plate area light adjuster, coupled to the panel, the backlight plate, the memory, and the timing control and calculator, and configured to adjust the plurality of first area peak luminance of the plurality of areas into a plurality of second area peak luminance according to the luminance adjustment value according to the luminance adjustment value, wherein when the luminance adjustment value is fractional, the plurality of first area peak luminance are different from the plurality of second area peak luminance.

7. The display device of claim 6, wherein the timing control and calculator is configured to detect and calculate the plurality of first area peak luminance of the plurality of areas of the panel and the backlight plate.

8. The display device of claim 6, wherein the display device comprises a power supply, wherein the power supply is coupled to a system motherboard, wherein the system motherboard is coupled to a power source, wherein the timing control and calculator is configured to determine the display device is in a performance mode or an energy-saving mode according to a state of whether the system motherboard is coupled to the power source or not.

9. The display device of claim 8, wherein the timing control and calculator is configured to detect a luminance of the panel in a first dynamic range mode or detect a luminance of the panel in a second dynamic range mode, wherein the luminance of the panel in the first dynamic range mode is different from the luminance of the panel in the second dynamic range mode.

10. The display device of claim 9, wherein when the timing control and calculator is configured to determine whether the display device is in one of the performance mode or the energy-saving mode according to a state of whether the system motherboard is coupled to the power source or not, wherein the timing control and calculator is configured to determine the panel in the first dynamic range mode or in the second dynamic range mode according to an instruction.
